(19) United States
(12) Patent Application Publication
(10) Pub. No.: US 2003/0225833 A1
(43) Pub. Date: Dec. 4, 2003

(54) Establishing multiparty communications based on common attributes

(76) Inventors: Paul Pilat, Portland, OR (US); Mary D. Smiley, Beaverton, OR (US); Michael S. Richmond, Beaverton, OR (US)

Correspondence Address: Mark S. Peloquin, Blakely, Sokoloff, Taylor & Zafman LLP, Seventh Floor, 12400 Wilshire Boulevard, Los Angeles, CA, 90025-1030, US

(21) Appl. No.: 10/160,551

(22) Filed: May 31, 2002

(51) Int. Cl. G06F 15/16

(52) U.S. Cl. 709/204; 725/37

(57) ABSTRACT

An apparatus and method includes receiving location information on a first user and a first selection from at least one electronic program guide (EPG), wherein the first selection is made by the first user. The first user is made aware of a chat room that may be of interest to the first user to join based on one of the following parameters, the first selection from the at least one EPG, information associated with the first selection from the at least one EPG, filter information associated with the first user, and the location information on the first user.

### BACKGROUND

1. Field

Embodiments of the invention relate generally to the field of establishing multiparty communications, and more specifically to establishing multiparty communications based on a user's manipulation of an electronic program guide.

2. Background

Multiparty communications are also known as chat rooms in Internet parlance. Chat rooms serve to connect people or users together across an information path so that communication is possible between at least two people. Presently, a user searches for a chat room to join. Users generally group together into chat rooms along lines of common interest. For example, various types of hobbies, sports, or entertainment can be the basis that a user uses when looking for a chat room to join.

The user's perspective is a poor one from which to make a decision about which chat room to join because the user does not have the most complete information about which chat rooms are available. Additionally, other users may have common interests that could be the basis for forming chat rooms not yet existing. When the user is left to join existing chat rooms by network search routines a less than complete experience is obtained. The users do not experience the level of community and commonality that could be achieved if more specific user information was used in the process of creating and joining chat rooms.

### BRIEF DESCRIPTION OF THE DRAWINGS

The invention may best be understood by referring to the following description and accompanying drawings that are used to illustrate embodiments of the invention. The invention is illustrated by way of example and is not limited in the figures of the accompanying drawings, in which like references indicate similar elements. In the drawings:

FIG. 1A illustrates a hardware architecture diagram for facilitating multiparty communications via chat rooms.

FIG. 1B contains a portion of an electronic program guide.

FIG. 2 shows functional processes for a method to provide multiparty communications to form chat rooms.

FIG. 3 illustrates inviting a user to join a chat room.

FIG. 4 illustrates private communications in a chat room.

### DETAILED DESCRIPTION

In the following detailed description, numerous specific details are set forth. However, it is understood that embodiments of the invention may be practiced without these specific details. In other instances, well-known circuits, structures, and techniques have not been shown in detail in order to not obscure the understanding of this description. These embodiments are described in sufficient detail to enable those of ordinary skill in the art to practice the invention. The following detailed description is, therefore, not to be taken in a limiting sense, and the scope of the invention is defined only by the appended claims.

User information is used to issue invitations to users to enter into multiparty communication or a chat room. User information is also used as a basis to create a new forum of multiparty communication (chat room) based on the similarity of user interests. User information is obtained from the user's navigation of an electronic program guide and/or selections made from the electronic program guide, over a network or Internet interface. User information is obtained and analyzed, and is then used as a basis for issuing the invitation(s) to join the chat room and/or the basis for creating a new chat room.

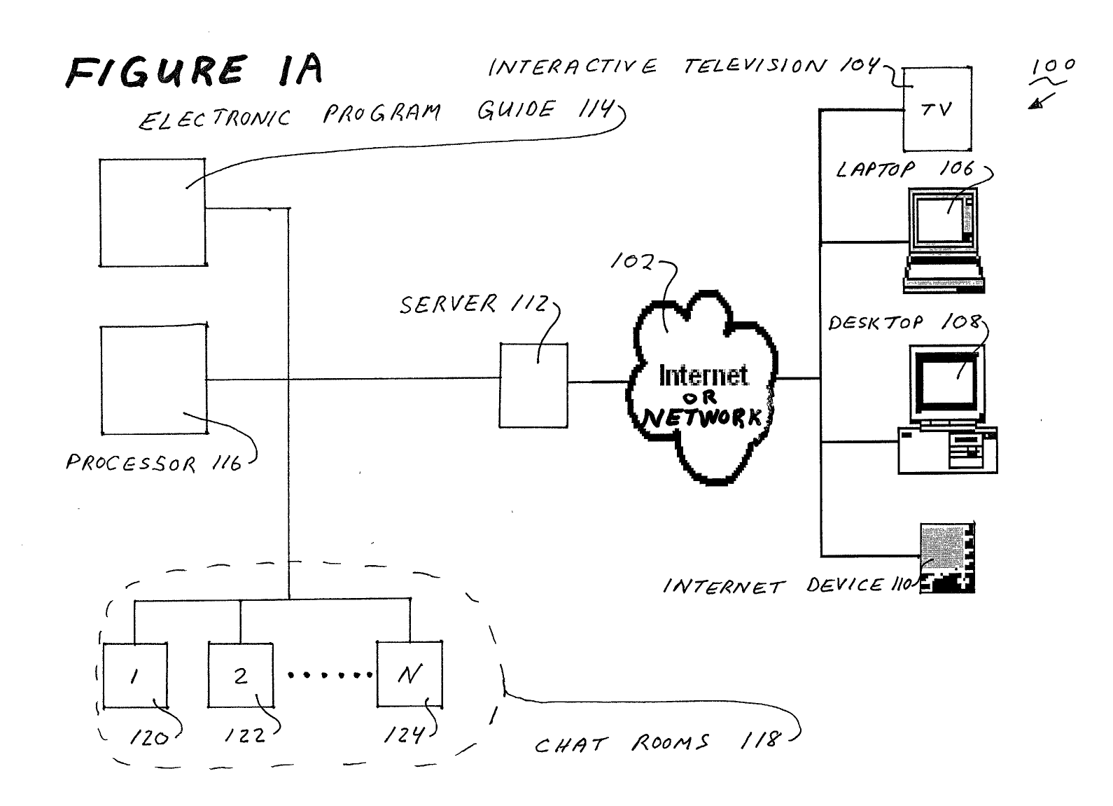

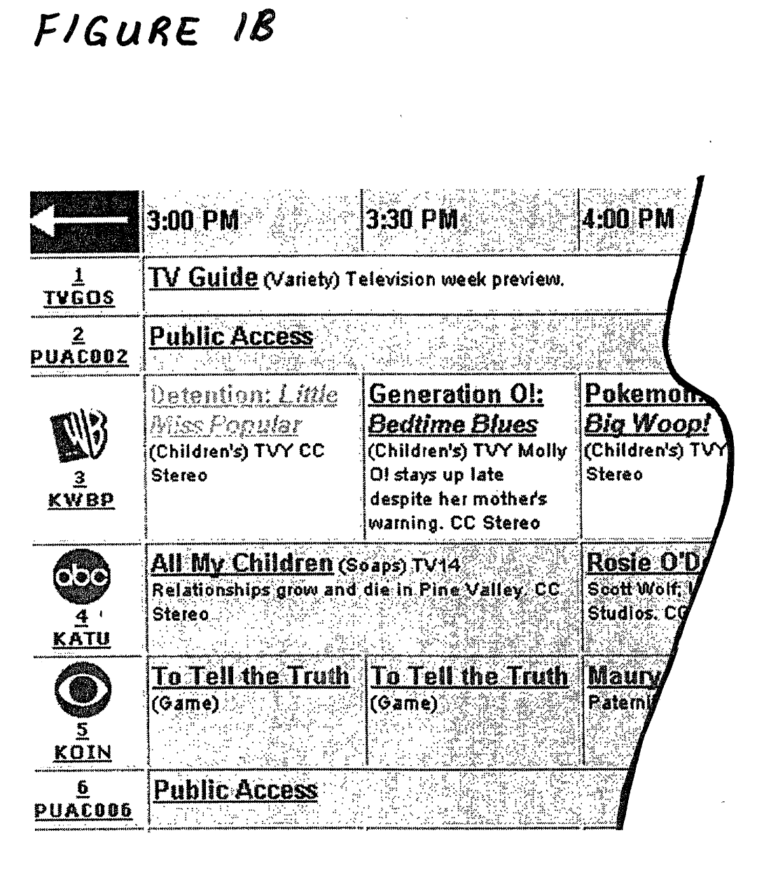

FIG. 1A illustrates a hardware architecture diagram 100 for facilitating multiparty communications. With reference to FIG. 1A, a network is illustrated in which a variety of Internet access devices can communicate with each other. An electronic program guide 114 contains a list of specific information. In one embodiment of the invention, the electronic program guide is a listing of television programming content that is available for consumption as a function of television channel and broadcast time as is shown in FIG. 1B. In another embodiment, the electronic program guide can be a listing of music selections that will be broadcast as a function of channel and broadcast time. In yet another embodiment, the electronic program guide can be a listing of course selections offered by a learning institution such as a high school or university. In yet another embodiment the electronic program guide can be a listing of media content downloadable from the Internet. The present invention is not limited by the content of the electronic program guide. In yet another embodiment, the electronic program guide can be a guide to data files. As used herein, the electronic program guide is meant to be a flexible listing of items. With reference back to FIG. 1A, the electronic program guide is available for viewing by means of server 112 on devices that can be used to communicate on the Internet or on another network such as an intranet. A non-exclusive list of such devices includes an interactive television 104, a laptop computer 106, a desktop computer 108, and an Internet device 110. The Internet device 110 can be any device that enables communication, such as a cellular telephone, a personal data assistant such as a handheld Palm™ device or an iPAQ™ device. The invention is not limited by the type of device used for multiparty communication. It will be noted by those of ordinary skill in the art that a non-interactive television can be equipped with a set-top box to provide the interactive functionality necessary to enable information to be sent from the television back to the network.

Multiparty communication refers to exchanging information in any format. For example, typing text by means of a key entry device such as a keyboard or using a pointing device such as a mouse, touch pad or stylus to select soft keys. Additionally, voice input can be used to facilitate communication. Video and/or voice can also be used to provide a format for communication. A deaf person could use a video camera to send sign language according to a format of communication contemplated within one or more embodiments of the invention. The invention is not limited by the format used for exchanging information during the multiparty communication.

A processor 116 can optionally be connected to the network 100. The processor 116 can perform the function of deciding whether to issue an invitation to a user to join a chat room and/or whether another chat room should be created. Alternatively, in another embodiment of the invention, server 112 can be used to decide whether to issue an invitation to a user to join a chat room and/or whether another chat room should be created. In one embodiment of the invention, the method of controlling the chat room invitations and formation is accomplished by an algorithm executed on a processor. Such an algorithm can run on processor 116 or server 112, as well as any of the Internet devices 104, 106, 108, and 110. The invention is not limited by where the algorithm is executed. For the rest of this discussion, the process of running an algorithm on a processor, to perform the chat room functions, will be termed the multiparty communications administrator (MCA). The MCA can be executed from any processor that is connected to the network.

A general number of chat rooms, N, is shown at 118, and the chat rooms are connected with the network as indicated by 120, 122, and 124. In one embodiment of the invention, the number of chat rooms can change dynamically as the number of users changes over time. In one embodiment, if the number of users grows beyond a predetermined number (assigned by the chat room user preference and/or the MCA) additional chat rooms can be added. Thus, more chat rooms can be added for a given subject or more chat rooms can be added to accommodate new user interests as time passes and user interests change.

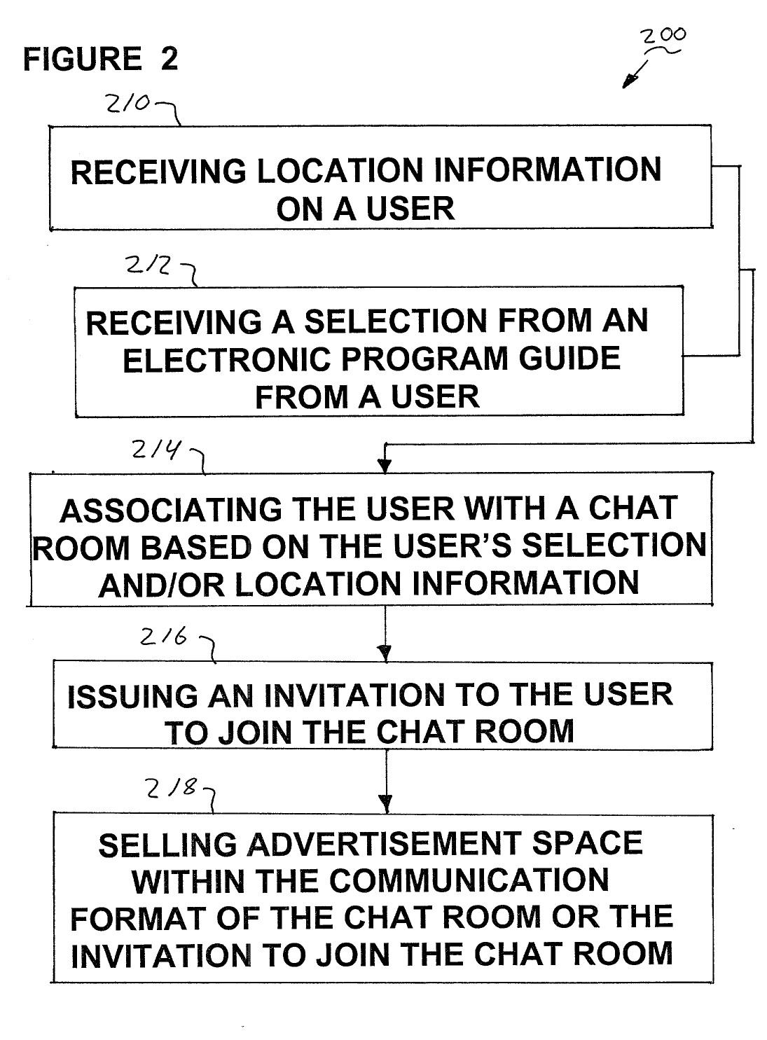

FIG. 2 shows functional processes for a method to provide multiparty communications by forming chat rooms. With reference to FIG. 2, information on a user is obtained when the user navigates an electronic program guide as shown at 210 or 212. The user navigates an electronic program guide in different ways depending on a design of a user interface. In one design of user interface, electronic program guide information is back fed to the MCA when the user allows the pointing device to highlight a field within the electronic program guide. In another design of user interface, electronic program guide information is back fed when the user selects a field within the electronic program guide. Methods of selecting a field are well known in the art, some examples include clicking a pointing device, touching a screen, and issuing a voice command. Server 112 (FIG. 1A) passes the back fed information to the MCA. As mentioned earlier, the MCA can be executed on any processor that is in communication with the network.

When user information is back fed from the electronic program guide, user identification information is also back fed which allows the MCA to associate the back fed electronic program guide information with the user. A back fed user's zip code can be used by the MCA to establish the user's location, as indicated by process block 210 (FIG. 2). User location information can be used to determine which chat room to associate the user with, as indicated by process block 214. In one embodiment of the invention, it may be desirable to group users together, into chat rooms, based on the geographic area in which they live. For example, users who live within a certain city or county could be grouped together. In another example, there may be only one chat room for all the users interested in a subject matter discussed in the single chat room across an entire state or country.

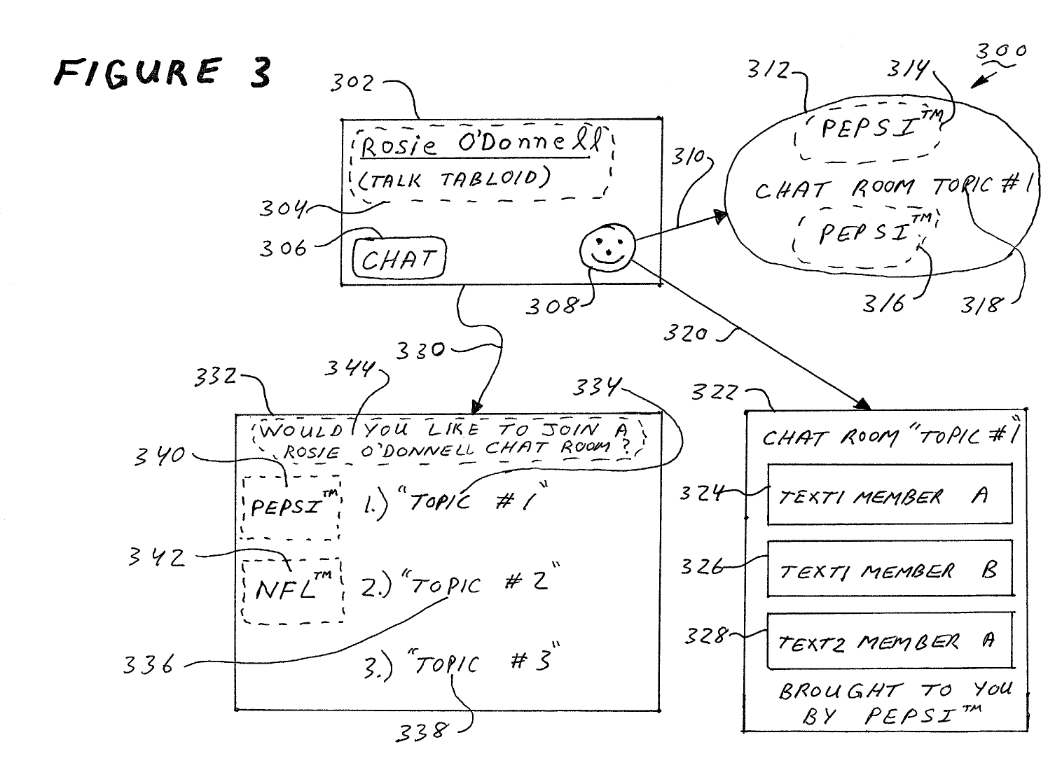

Once the MCA has associated the user and the chat room, the user is made aware of the chat room that the MCA has determined might be of interest to the user at process block 216. The user is made aware of the chat room determined by the MCA in various ways. In one embodiment of the invention, an invitation to join the chat room is sent to the user. In another embodiment of the invention, an interactive symbol can be added to the electronic program guide, which allows the user to enter the chat room by selecting the interactive symbol. Selecting the interactive symbol is performed by means that are well known in the art. Further discussion pertaining to making the user aware of the chat rooms that are available based on the determination of the MCA is provided in support of FIG. 3. Information display area can be contracted to interested parties, resulting in income from selling or renting advertisement space from within the communication format of the chat room (further discussion in support of FIG. 3).

FIG. 3 illustrates several embodiments of the invention wherein the user is made aware that a chat room may be of interest to the user. With reference to FIG. 3, a program entry from the electronic program guide of (FIG. 1B) is shown at 302 (FIG. 3). The electronic program guide entry 302 is for the Rosie O'Donnell show, as indicated by the text contained within a region of the information display indicated by 304. Interacting with the region demarcated by 304, when the user is navigating the electronic program guide, can cause electronic program guide information to be back fed to the MCA. Selecting the region 304 can also cause electronic program guide information to be back fed to the MCA. The user is made aware of potential chat rooms of interest according to several embodiments of the invention.

In one embodiment, an icon can be used to indicate a chat room. An icon labeled “CHAT” is shown at 306 and an icon in the shape of a smiley face is shown at 308. These icons can be configured as “buttons,” which are regions of the information display, that respond to excitation or selection by means that are well known in the art, such as but not limited to: clicking, touching, voice command, etc. The icon can also be responsive to selection by means of positioning a pointing device such as a cursor over the icon. In this scenario a pop-up window can appear just as if the “button” was selected. Two examples of pop-up windows are shown with 312 and 322. In one embodiment, pop-up window 312 contains a link to a chat room as indicated by 318. The user could enter the chat room by selecting 318, labeled “CHAT ROOM TOPIC #1. The pop-up window 312 is a non-limiting example of an area of the information display on which advertisement space can be sold or leased. An example of selling or leasing advertising space is the trademark “PEPSI™” within area 316 and area 314.

In another embodiment of the invention, selecting 308 results in pop-up window 322, which allows the user to enter directly into chat room communication. Within the view shown in 322 are communications from two members A, and B in the form of text. Text1 from Member A is depicted at 324, Text1 from Member B is depicted at 326, and Text2 from Member A is depicted with 328. The pop-up window 322 contains a label indicating that this is “CHAT ROOM “TOPIC 1”” and that the sponsor is PEPSI™. The terms user and member are interchangeable within this description as applied to people within a chat room.

Multiple chat rooms can exist for a given selection from the electronic program guide. An example of multiple chat rooms is shown in pop-up window 332. Three different chat rooms are indicated by 334, 336, and 338. The advertisements that reflect the sponsors of the individual chat rooms are indicated by 340 and 342. As mentioned earlier, the advertisement space created within the pop-up window can be sold or leased. The user is prompted to join the chat rooms by means of a question “Would You Like To Join A Rosie O'Donnell Chat Room?” at 344. The present invention is not limited by the method employed to make the user aware of a chat room that may be of interest or of the invitation to join one or more chat rooms.

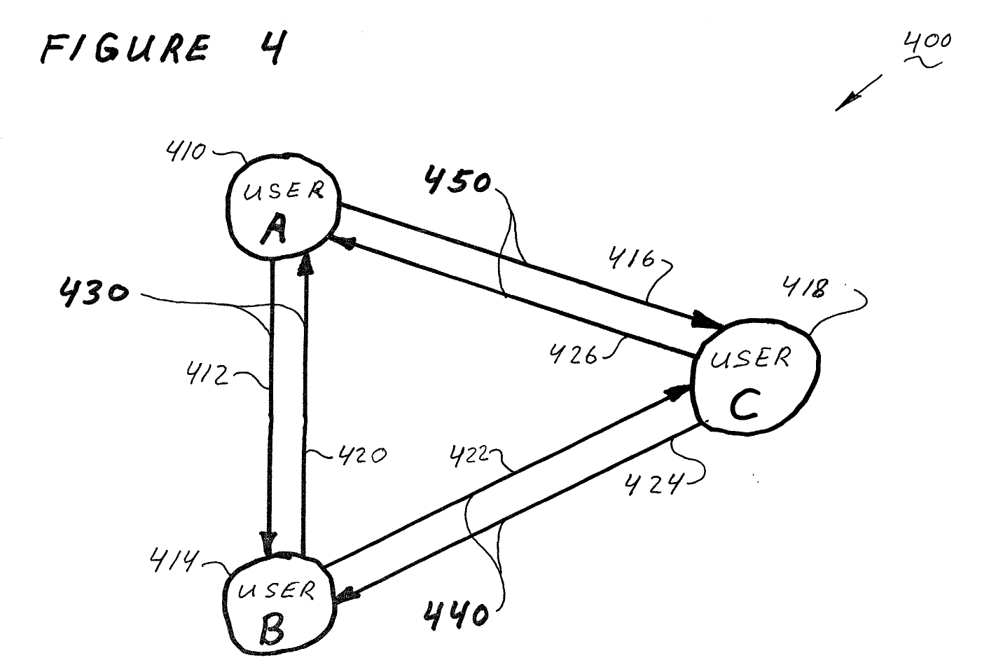

The present invention is not limited by the number of users in a chat room. In one or more embodiments of the invention, the chat room can be limited to a fixed number of users. A non-limiting example of limiting the chat room to a fixed number of users is a two-user chat room. The limitation on the number of users in the chat room can be imposed on users by the design of the system such as in the AOL Instant Messenger™ system employed by America On Line™ where communications between two particular users are private. Or the number of users in the chat room can be self-imposed by a user(s). An example of limiting the number of users in a chat room to create private communication is shown in FIG. 4.

With reference to FIG. 4, user A 410 is in a chat room 430 with user B 414. Within the chat room 430, user A 410 can send a message 412 to user B 414 and user B 414 can send a message 420 to user A 410. A second chat room 440 exists between user B 414 and user C 418. Within the chat room 440, user B 414 can send a message 422 to user C 418 and user C 418 can send a message 424 to user B 414. Message 412 is limited to user B 414 and message 420 is limited to user A 410 within chat room 430. Similarly, message 422 is limited to user C 418 and message 424 is limited to user B 414. A third chat room 450 can exist if the users so chose between the user C 418 and the user A 410. Within the third chat room 450 user C 418 can send message 426 to user A 410 and user A 410 can send message 416 to user C 418. Message 426 is limited to user A 410 and message 416 is limited to user C 418 within chat room 450. When the chat room is intentionally limited to two users, communications only occur between the two users therein.

The topic being discussed within the chat rooms 430, 440, and 450 can be directed to the same topic, for example “TOPIC #1” at 334 in FIG. 3 or chat room 430 could be supporting a different topic of conversation than the topic of conversation that 440 is supporting. For example, chat room 430 could be supporting “TOPIC #1” at 334 (FIG. 3), chat room 440 could be supporting “TOPIC #2” at 336 (FIG. 3), and chat room 450 could be supporting “TOPIC #3” at 338 (FIG. 3). In one or more embodiments, the users can change the topic of discussion in the chat room once the connection is made between the first and second users that have been paired up into the chat room.

A non-limiting example of the present invention as applied to television broadcast content is creating multiparty communication with respect to the Academy Awards. Many people can view the Academy Awards across the country. As users select the Academy Awards to watch on television, back fed information is used by the MCA, as previously described to form chat rooms. The back fed information is filtered by geographic area, as well as user profiles which can be submitted by the users to supply more specific information on the kind of subject or person the user wishes to communicate with. For example, the user may be interested in “best movie,” “best director,” “best cartoon,” or best actor.” This information can be used by the MCA to issue invitations to join appropriate chat rooms already existing or to join chat rooms that will be created based on favorable responses from users that are interested in joining chat rooms not yet in existence.

For example, user information that is back fed to the MCA may indicate that a number of people wish to discuss the clothes that a certain star wore to the Academy Awards dinner. As the MCA counts an increasing number of such requests a “potential” chat room can be formed. The “potential” chat room does not actually have multiparty communications occurring yet. In one embodiment, the chat room remains potential until a user accepts an invitation to join the chat room at which time the chat room turns from being a potential chat room to an actual chat room. In one embodiment, whether a chat room exists or not is a matter to be decided by the MCA. Therefore, it is possible to have a chat room with one user in it or a plurality of users in it or a limited number of users as previously described. The number of people in a chat room does not limit the present invention.

In one or more embodiments of the present invention, the user can define a filter, which pertains to communication preferences. The filter can also function as a user profile specifying what the user would like to be associated with or not associated with. In one embodiment of the invention, the filter/profile information is communicated to the MCA and is used when the MCA determines which chat rooms might be of interest to the user. For example, the user could specify chat room size; i.e., no more than 12 people in the chat room. The user could specify no pornography as well as specify desired topics such as the clothes that a certain star wore to the Academy Awards dinner as mentioned above. It will be apparent to those of ordinary skill in the art that many different filters/profiles can be applied to filter the user information and to assist the MCA in determining which chat room might be of interest to the user or what kind of chat room might be good to create. The present invention is not limited by the filter applied to the user information or lack of filter applied to the user information.

In one or more embodiments, the invitation to a given user to join a chat room can come from the MCA in the form of a “buddy list” compiled for a given user, based on back fed information (previously described) and filter/profile information (described above). The buddy list is then sent to the given user and chat rooms are configured accordingly. The size of the chat room and the limits on the communications described above in conjunction with FIG. 4 can be applied to create one or more chat rooms wherein the communications between two users are private.

As previously discussed in conjunction with FIG. 1A, many different types of devices can be used to facilitate multiparty communications according to the teaching of the invention. Accordingly, a cellular telephone capable of navigating the electronic program guide could be used to allow the user to participate in the multiparty communication. The cellular telephone could be designed to back feed appropriate location information, such as cell identification information, which would establish where the phone transmission was originating. Another way to generate location information is to use global positioning system (GPS) signals. GPS signals can be used in a variety of ways to provide the necessary location information. If the cellular telephone was capable of establishing communication with a GPS receiver, the telephone could receive location information directly from the GPS receiver and send the information back to the MCA. In one embodiment, the GPS receiver would be co-located with the cellular telephone.

It will be appreciated that the methods described in conjunction with the figures may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions, which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

While the invention has been described in terms of several embodiment, those skilled in the art will recognize that the invention is not limited to the embodiments described, but can be practiced with modification and alteration within the spirit and scope of the appended claims. The description is thus to be regarded as illustrative instead of limiting. Accordingly, all such variations and modifications are included within the intended scope of the invention as defined by the following claims.

What is claimed is:

1. A method comprising:
receiving a first selection from at least one electronic program guide (EPG), wherein the first selection from the at least one EPG is made by the first user; and
making the first user aware of a chat room that may be of interest to the first user to join based on a parameter selected from the group consisting of the first selection from the at least one EPG, information associated with the first selection from the at least one EPG, and filter information associated with the first user.

2. The method of claim 1, further comprising:
receiving location information on a first user.

3. The method of claim 1, wherein the location information is obtained from a zip code.

4. The method of claim 1, wherein information associated with the first selection made from the at least one EPG is selected from the group consisting of program air time, program title, program subject matter, program distribution area, and the filter information associated with the first user.

5. The method of claim 1, further comprising:
providing a first invitation to the first user to join the chat room.

6. The method of claim 5, wherein the providing the first invitation is communicated to the first user on a data display selected from the group consisting of a laptop computer, a desktop computer, a television, an internet device, a cellular telephone, and a personal data assistant.

7. The method of claim 1, further comprising:
providing a second invitation to the first user to join the chat room based on a previous participation of the first user in the chat room.

8. The method of claim 1, further comprising:
receiving a second selection from the at least one EPG, wherein the second selection from the at least one EPG is made by a second user; and
grouping the first user and the second user together to form a chat room based on a parameter selected from the group consisting of the first selection from the at least one EPG, the second selection from the at least one EPG, information associated with the first selection from the at least one EPG, and information associated with the second selection from the at least one EPG.

9. The method of claim 8, wherein the chat room is limited to the first user and the second user.

10. The method of claim 9, further comprising:
receiving a third selection from the at least one EPG, wherein the third selection from the at least one EPG is made by a third user;
grouping the third user with a user selected from the group consisting of the first user, and the second user to form a second chat room that is limited to the grouping.

11. The method of claim 8, further comprising:
receiving location information on the second user.

12. The method of claim 8, wherein the Internet is used to enable communication between the first user and the second user.

13. The method of claim 8, wherein information associated with the second selection made from the at least one EPG is selected from the group consisting of program air time, program title, program subject matter, program distribution area, and the filter information associated with the first user.

14. The method of claim 8, further comprising:
making a second user aware of the chat room that may be of interest to the second user to join.

15. The method of claim 8, further comprising:
providing a first invitation to the second user to join the chat room.

16. The method of claim 8, further comprising:
providing a second invitation to the second user to join the chat room based on a previous participation of the second user in the chat room.

17. The method of claim 1, wherein the at least one EPG is selected from the group consisting of a guide to television programs, a guide to data files; a guide to media content downloadable from the Internet, and a guide to music files.

18. The method of claim 1, further comprising:
selling a right to use information display area, for a period of time, within a region of an information display designated for the chat room.

19. The method of claim 18, wherein the right to use the information display area is sold for money.

20. The method of claim 18, wherein the right to use the information display area is traded for similar value.

21. A method comprising:
receiving a first selection from at least one electronic program guide (EPG), wherein the first selection from the at least one EPG is made by a user; and
identifying the user for a potential chat room based on a parameter selected from the group consisting of the first selection from the at least one EPG, information associated with the first selection from the at least one EPG, filter information associated with the user, and location information on the user.

22. The method of claim 21, further comprising making the user aware of the potential chat room to join.

23. The method of claim 22, further comprising forming a second chat room from the potential chat room after the user accepts the invitation to join.

24. An apparatus comprising:
a means for collecting information from a user;
a means for assigning the user to a chat room that may be of interest to the user to join, based on the information;
a means for notifying the user that the chat room may be of interest to the user to join.

25. The apparatus of claim 24, further comprising a means for associating advertisement information with the communication area within the chat room.

26. The apparatus of claim 24, wherein only two users communicate in the chat room.

27. An apparatus comprising:
a network, wherein a user is to receive media content;
an electronic program guide to be transmitted on the network;
a processor coupled with the network to analyze a selection made by the user from the electronic program guide; and
a chat room, wherein the user is invited to join the chat room based on the selection made by the user from the electronic program guide.

28. The apparatus of claim 27, wherein the user is invited to join the chat room a second time based on the user joining the chat room at a prior time.

29. The apparatus of claim 27, wherein the user is identified for a potential chat room based on a selection made by the user from the electronic program guide.

30. The apparatus of claim 29, further comprising an invitation to the user to join the potential chat room.

31. The apparatus of claim 30, further comprising a second chat room to be formed after the user accepts the invitation to join.

32. A computer readable medium containing executable computer program instructions, which when executed by a data processing system, cause the data processing system to perform a method comprising:
receiving a selection from an electronic program guide (EPG); and
providing an invitation to the user to join a chat room based on a parameter selected from the group consisting of the selection from the EPG, information associated with the selection from the EPG, filter information associated with the user.

33. The computer readable medium as set forth in claim 32, wherein information associated with the selection made from the EPG is selected from the group consisting of program airtime, program title, program subject matter, program distribution area, and the filter information associated with the user.

34. The computer readable medium as set forth in claim 32, wherein the EPG is selected from the group consisting of a guide to television programs, a guide to data files; a guide to media content downloadable from the Internet, and a guide to music files.

35. The computer readable medium as set forth in claim 32, wherein the method further comprises identifying a user for a potential chat room based on the receiving the selection from the EPG.

36. A computer readable medium containing executable computer program instructions, which when executed by a data processing system, cause the data processing system to perform a method comprising:
receiving an electronic program guide (EPG);
navigating the EPG; and
accepting an invitation to join a chat room, wherein the invitation to join the chat room was given in response to the navigating the EPG.

37. The computer readable medium as set forth in claim 36, wherein the EPG is selected from the group consisting of a guide to television programs, a guide to data files; a guide to media content downloadable from the Internet, and a guide to music files.
